(19) United States
(12) Patent Application Publication
(10) Pub. No.: US 2015/0332128 A1
(43) Pub. Date: Nov. 19, 2015

(54) NETWORK-IMPLEMENTED METHODS AND SYSTEMS FOR AUTHENTICATING A PAPER FINANCIAL INSTRUMENT

(71) Applicants: Alex Sadovsky, Toronto (CA); Alexey Plotkin, Thornhill (CA)

(72) Inventors: Alex Sadovsky, Toronto (CA); Alexey Plotkin, Thornhill (CA)

(21) Appl. No.: 14/715,525

(22) Filed: May 18, 2015

Related U.S. Application Data
(60) Provisional application No. 61/994,940, filed on May 18, 2014.

(51) Int. Cl. G06K 9/72; G06K 9/00; G06K 17/00; G06K 9/03

(52) U.S. Cl. CPC G06K 9/726; G06K 9/03; G06K 9/00463; G06K 17/0016; G06K 2209/01; G06K 2009/00489

(57) ABSTRACT

The disclosure relates generally to financial instruments and particularly to mitigating exposure to financial fraud. Specifically, the disclosure relates to systems and methods of authenticating paper financial instruments (PFI) issued by a first entity for the benefit of a third party.

### BACKGROUND

The disclosure is directed generally to financial instruments and particularly to mitigating exposure to financial fraud. Specifically, the disclosure is directed to systems and methods of authenticating paper financial instruments issued by a first entity for the benefit of a third party.

Financial Institutions are faced with increased exposure to financial losses and fraud on a daily basis, with transactions associated with acceptance and negotiating of Money Orders, Drafts, Certified Checks, Cashier Checks, Governmental refund paper checks, Government (local and other) payroll checks, social security checks, welfare and pension checks and the like, (referred to herein as “paper financial instruments” or interchangeably, “item(s)”, or PFI).

The aforementioned financial paper instruments can hold a unique product design and be marketable in the financial and banking system. The items, when purchased, can be fully paid for by the purchaser at the time of transaction, and hence referred to in the industry as “cleared funds” or “guaranteed funds”, because the bank, rather than the purchaser, is responsible for paying the amount. Many consumers and businesses favor these instruments as it gives the recipient comfort and security in knowing the funds are “guaranteed” by the bank and there is immediate access to the funds as needed, without any ‘hold’ periods.

However, for the past several years, the nature of these instruments has been posing an increased risk for many financial institutions. Many banks are continuously faced with altered, counterfeit or fraudulent items with no possibility to verify authenticity of the item prior to its ‘clearing’ overnight. Even with overnight ‘clearing’ procedure, banks may be potentially faced with financial losses as it may not be immediately known that an item in question is fraudulent. The aforementioned financial instruments are most favored in the criminal sphere, due to the “guaranteed” features and trust factor by the banks.

Some financial institutions have stopped verifying these items by phone, fax or e-mail altogether, due to numerous human errors resulting in substantial financial losses and legal liability exposure. As such, due to increased risks and lack of reliable authentication tools for the items, banks are forced to freeze access to these funds upon deposit for a few business days (sometimes up to 4 days), until a formal ‘clearing’ and some form of authentication can take place. This process can be a major inconvenience, a sore point to customers and a major risk factor for banks often resulting in significant financial losses.

Likewise, it is safe to say that all businesses are faced with some level of fraud associated with checks. Financial institutions offer fraud mitigation and or protection to the largest commercial customers—creating a gap for small businesses. Small and medium business—defined as companies with annual revenues of less than 100 MM and less than 100 employees (herein referred to as “SMB”) can therefore be faced with significant fraud and risk associated with company business checks issued to suppliers, vendors, employees, government and the like. Many SMBs are targeted by cons for issued business checks as part of significant fraud schemes. The business checks, often intercepted by mail and altered for amounts, payee, dates and others—cause significant financial losses for the businesses.

Although digital forms of payments solutions are available by financial institutions, majority of SMBs still prefer to use paper business checks as it allows to extend cash flow (checks in the mail allow businesses to extend cash flow management, along with substantial cost savings). Financial institutions who understand consumer preferences have created service solutions for big commercial customers. The solutions offer complicated check fraud mitigation services to largest commercial customers such as insurance company for a very significant cost amount per check. Such solutions are not available for SMBs in general due to smaller scale and financial costs that financial institutions charge.

Accordingly, there is a need for providing a rapid verification and authentication systems and methods that can be used by large financial institutions, which can also be used effectively by SMBs.

### SUMMARY

In an embodiment, provided is a system for authentication and verification of a paper financial instrument comprising: a first data access module comprising at least one imaging subsystem; an image processing module; a second data access module comprising at least one imaging subsystem a data processing module comprising: a memory; and a processor in communication with the memory, the first data access module, the second data access module, and the image processing module, wherein the processor is configured to: receive a first image corresponding to a first financial instrument from the first data module; receive a second image corresponding to the second data access module; partition the first image into a plurality of fields; partition the second image into the same plurality of fields; compare the plurality of fields of the second image to the plurality of fields of the first check image in order to determine a level of similarity between the second image and the first image; determine the degree of similarity between the first image and the second image; and if the degree of similarity is above a predetermined value, provide an authentication indicia to the second data access module.

In another embodiment, provided herein is a method of authenticating a paper financial instrument, comprising: receiving a first image corresponding to a first paper financial instrument from a first data module; receiving a second image corresponding to a second paper financial instrument from a second data access module; partitioning the first image into a plurality of fields; partitioning the second image into the same plurality of fields; comparing the plurality of fields of the second image to the plurality of fields of the first check image in order to determine a level of similarity between the second image and the first image; determining the degree of similarity between the second image and the first image; and if the degree of similiarity is above a predetermined threshold value, providing an authentication indicia to the second data access module.

In yet another embodiment, provided herein is a non-transitory computer-readable medium comprising computer-readable instructions for authenticating a paper financial instrument, said computer-readable instructions configured for causing a processor to: receive a first image corresponding to a first financial instrument from a first data module; receive a second image corresponding to a second financial instrument from a second data access module; partition the first image into a plurality of fields; partition the second image into the same plurality of fields; compare the plurality of fields of the second image to the plurality of fields of the first check image in order to determine a level of similarity between the second image and the first image; determine the degree of similarity between the first image and the second image; and if the degree of similarity is above a predetermined threshold value, provide an authentication indicia to the second data access module.

### BRIEF DESCRIPTION OF THE DRAWINGS

The features of the systems and methods of authenticating paper financial instruments described will become apparent from the following detailed description when read in conjunction with the drawings, which are exemplary, not limiting, and in which:

FIG. 1, illustrates a flow chart describing image capture of the paper financial instrument by the institutional issuer;

FIG. 2, illustrates a flow chart describing image capture of the paper financial instrument by the institutional payor and comparison validation;

FIG. 3, illustrates a flow chart describing image capture of the paper financial instrument by e.g., SMB issuer;

FIG. 4, illustrates a flow chart describing image capture of the paper financial instrument by e.g., SMB payor and comparison validation

FIG. 5, illustrates a flow chart describing image capture of the paper financial instrument by ATM and comparison validation;

FIG. 6, shows a block diagram of the paper financial instrument authentication and/or verification (FIAV) system architecture;

FIG. 7 shows a block diagram of end user paper FIAV system station;

FIG. 8 illustrates an embodiment of the verification and authentication algorithm of a financial instrument by institutional entity with the ASP; and

FIG. 9, illustrates an embodiment of the verification and authentication algorithm of a financial instrument by SMB entity with the ASP.

While the disclosure is amenable to various modifications and alternative forms, specifics thereof have been shown by way of example in the drawings and will be further described in detail herein below. It should be understood, however, that the intention is not to limit the disclosure to the particular embodiments described. On the contrary, the intention is to cover all modifications, equivalents, and alternatives.

### DETAILED DESCRIPTION

The disclosure relates in one embodiment to financial instruments and particularly to mitigating exposure to financial fraud. In another embodiment, the disclosure relates to systems and methods of authenticating paper financial instruments issued by a first entity for the benefit of a third party.

In an embodiment, the authentication service provider (ASP) provides innovative solution that allows banks and other financial institutions to substantially reduce risk and fraud associated with financial instruments before depositing items (financial instruments) into an account and assuming any financial or operational risk or liability. The solution is based in an embodiment on a new and unique processes that can involve an algorithm that works together with a check scanner, Optical Character Recognition (OCR), Intelligent Character Recognition (ICR), Image Mapping Comparison, and Magnetic Ink Character Recognition (MICR) to validate the authenticity of the item. After the item is scanned, the system can advise the bank (via software messaging), whether that item is secured (in other words, authentic), and can be deposited with no assumed risk, or conversely warns that the item is fraudulent.

The systems and methods provided herein are configured enable SMB customers to reduce risk and fraud associated with their own issued business checks and other financial instruments, prior to their clearance. Accordingly, disclosed herein are embodiment of business processes that utilize, inter-alia, an algorithm that works together with a check scanner or smartphone camera (or other image capturing devices), Optical Character Recognition (OCR) subsystems, Intelligent Character Recognition (ICR) subsystems, Image Mapping and Comparison subsystems, and Magnetic Ink Character Recognition (MICR) subsystems to validate the authenticity of the business check. In an embodiment, After the item is captured via scanner, smartphone camera or other form of image capturing, or by receiving the check data from the data file, the receiving system can be configured to advise a financial institution (via, for example, on screen messaging), whether that item is safe and can be deposited with no assumed risk, or warns SMB customer of possibility of fraudulent.

The systems and methods can therefore be configured for protecting and minimizing the SMB business owners from exposure and vulnerability to check fraud; and provide bigger corporate clients such as, for example, car dealerships, check cashing businesses and other bigger corporates (large organizations that receive checks) to validate and authenticate the checks they receive. Accordingly and in an embodiment, provided herein is a system for authentication and verification of a paper financial instrument comprising: a first data access module comprising at least one imaging subsystem; an image processing module; a second data access module comprising at least one imaging subsystem a data processing module comprising: a memory; and a processor in communication with the memory, the first data access module, the second data access module, and the image processing module, wherein the processor is configured to: receive a first image corresponding to a first financial instrument from the first data module; receive a second image corresponding to the second data access module; partition the first image into a plurality of fields; partition the second image into the same plurality of fields; compare the plurality of fields of the second image to the plurality of fields of the first check image in order to determine a level of similarity between the second image and the first image; determine the degree of similarity between the first image and the second image; and if the degree of similarity is above a predetermined value, provide an authentication indicia to the second data access module.

The term “subsystem” is used in an embodiment, to include both the hardware and firmware components that accomplish these functions. Likewise and in another embodiments, the term “module” with respect to a system may refer to a hardware component of the system, a software component of the system, or a component of the system that includes both hardware and software.

In an embodiment, the systems and methods described herein allow banks to substantially minimize fraud associated with aforementioned financial instruments by utilizing a unique algorithm and check scanners. The technology allows, for example, the receiving branch (or ATM, tablet, phablet, PDA, Smartphone, Computer, e.g., the second data access module) to validate authenticity of items prior to depositing, based on magnitude of different parameters that are captured and later analyzed by the system when the item is issued and verified. As such, upon issue of any of the financial items mentioned, the bank scans them using the scanner into a highly secured database. Numerous characteristics are captured by the software and stored. For a bank that is negotiating a paper item, a quick scan using their scanner and “SmartyCheck Verified”™ software will confirm authenticity of the item, relative to its original condition at time of issue.

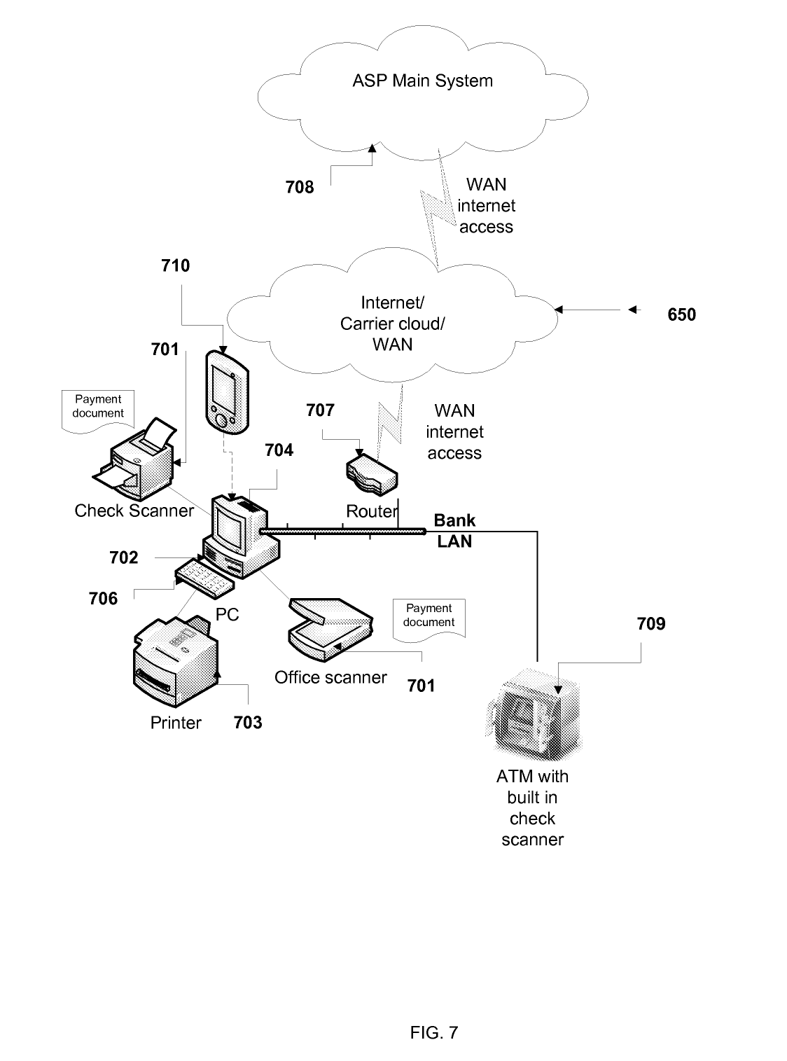

As illustrated in FIG. 7, the issuing or paying user station can comprise, for example, a Check scanner 701 (imaging subsystem) optionally with dual-sided scanning capabilities for complete image capture of both sides of the check with MICR, (with a minimal resolution of about 200 dpi), computer 702, printer 703, standard monitor 704, pointing device 705 (not shown) and keyboard 706, and secured connection 707 to a system server 708 and optionally a secured connection to an automatic teller machine 709

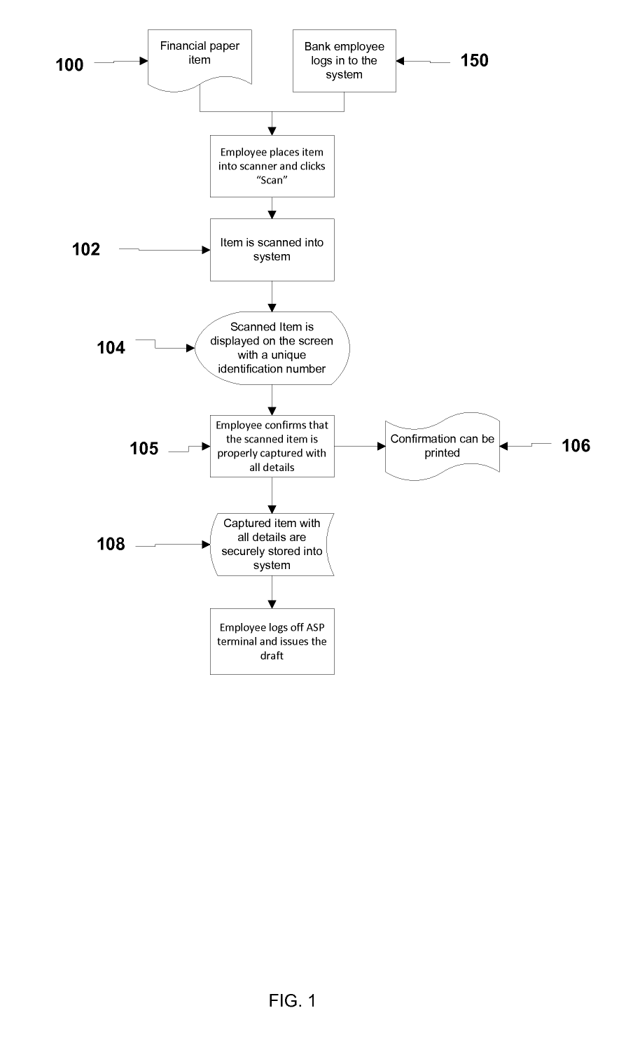

In an embodiment, the software can be based on customized algorithms that utilize Optical Character Recognition (OCR),Intelligent Character Recognition (ICR), Image Mapping and Comparison, and Magnetic Ink Character Recognition technologies. As illustrated in FIG. 1, when a bank employee (user) logs into the system 101, two main options are provided; “Register Item” (pre issuance) or “Verify Item” (e.g., deposit, or pre-payment PFI). With the “Register Item” option, a teller places the check into the scanner 102 and clicks the “Scan” button. The draft passes through the scanner and the image processing module partitions the captured image to key areas (fields) of financial instrument 100. The fields can be, for example, a magnetic ink character recognition (MICR) line, Overall image as a whole, Date, Serial number, All signatures, Payee Name, Amount CAR/LAR, Issuing bank and branch details, Protectograph and magnetic ink values, Hand written or printed item value. Partitioned fields are then displayed on the screen with unique identification numbers and displayed to the user 104. The financial instrument parameters are being captured and stored with relevant data into a database on a connected secure server. A message box appears to let the user know that the system captured the financial instrument 100 and successfully uploaded them to the server 108.

Also illustrated in FIG. 1, various confirmation steps are also incorporated into the process, such as, for example, Employee (or first user) 150 can confirm that the scanned item is properly captured with all pertinent details 105, and once scanned, the captured image of financial instrument 100 can be stored locally at the first data access module, or on the Authentication Service Provider's management server (not shown).

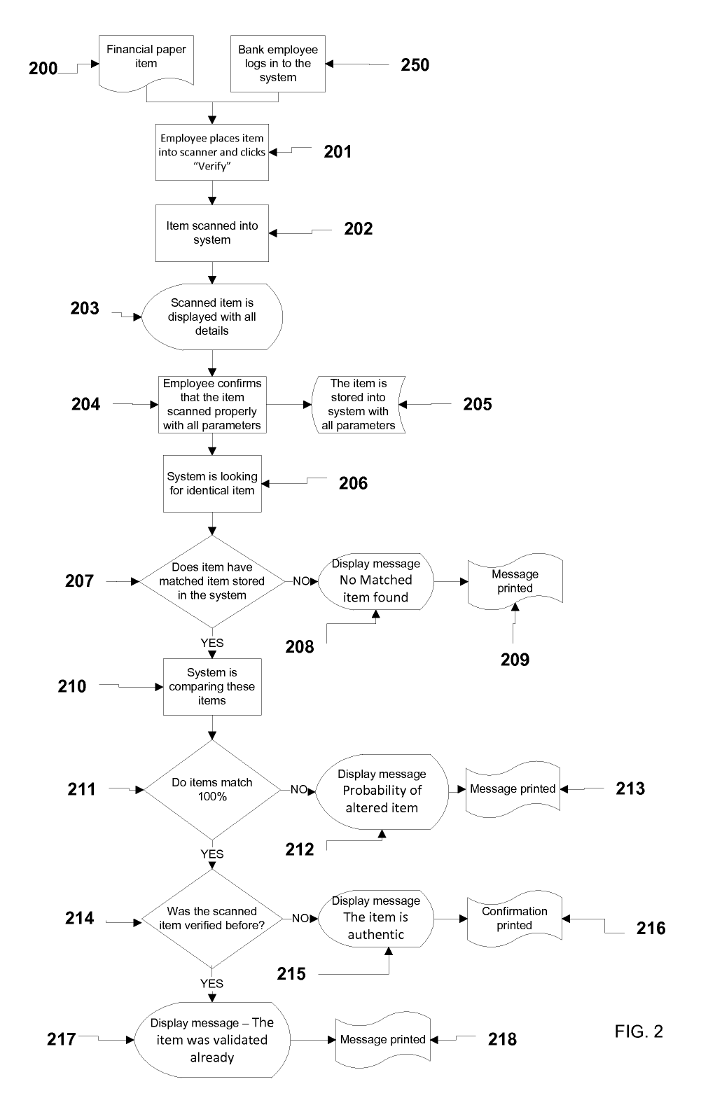

As illustrated in FIG. 2, and before payment, the user in the second data access module (user station, see e.g., FIG. 7), scans financial instrument(s) 200 for validation, he/she will click “verify item” and put the item through for scanning 201. As the item is being scanned by the system 202, all the attributes are being recognized, mapped and searched in the database for a match. The following messages and their associated definitions can appear in the message box based on authentication results:

Authentic Item 215 (indication is provided to the user)=a match has been found in the system with no previous authentication attempts 217. There is no reason to believe that the item was altered 212 in any form or fashion. Safe to deposit without hesitation of fraud.

No Match Found 208 (a different indication is provided to the user)=no matching item has been found in the system (item may have not been scanned into the database by issuing branch) (See e.g., FIG. 1).

Possibly Altered Item 212—The key attributes and parameters match, however, the item does not match in some aspects to the originally issued item. Deposit at own discretion. (indicated by pre-selected font color).

Duplicate Item 218 (another indication is provided to the user)=match has been found in the system; however, a different financial institution has already scanned the item once or more. Depositing branch is to be cautious to avoid duplicate deposits.

Bank employee (end user) can then print the confirmation/message (209, 213, 216, 218) along with or without the originally scanned image, with a unique confirmation number and item details at the time of scan

As also shown in FIG. 2, several decision points are incorporated into the authentication and or validation process of the image captured in the second data access module. These include bifurcation of the process based on whether or not the image matches any image stored on the data processing modules' memory 207; if a match exists and following a comparison by the data processing module 210, whether or not the plurality of fields identified and partitioned in the first image are identical to the plurality of fields identified and partitioned in the second image 211; and if identical, whether or not the first image (see FIG. 1, 108) has already gone an authentication/verification process 214 by another end user 250 at another location and has therefore been paid to the holder. In other words, providing at least a reasonable evaluation on whether or not the financial instrument being verified can be a duplicate.

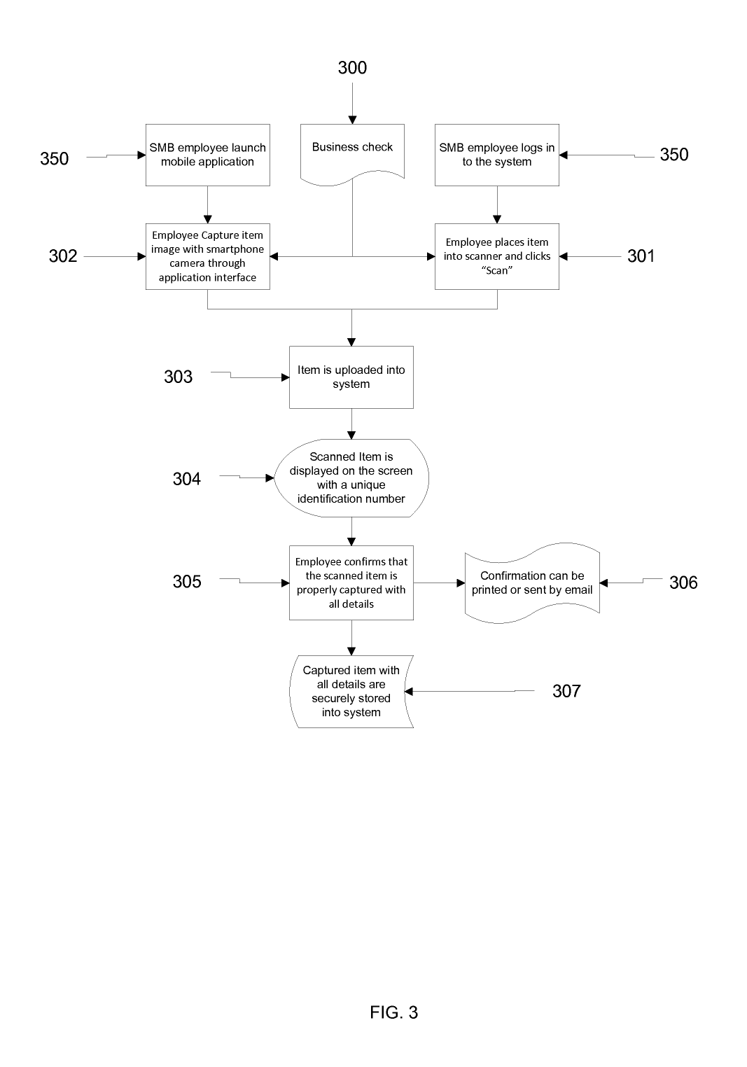

Similar to an institution, the first data access module can be a small to medium business that can issue business checks to various suppliers, vendors, capital expenditure projects, taxes and the like. As illustrated in FIG. 3, when a SMB's user 350 issues a business check, 300 they can capture the first image of the check using either a dedicated check scanner 301 comprised in the first data access module (see e.g., 701, FIG. 7), an office scanner (see e.g., FIG. 7), or a PDA 302 (see e.g., 710, FIG.7) in wired or wireless communication with a computer (702, FIG. 7). At which point, the scanned first image of financial instrument 300 (e.g., an issued business check) is uploaded (e.g., through WAN network) to the ASP's system 303, using the data processing module, in combination with the image processing module, the first image of financial instrument 300 is partitioned to a plurality of fields as described herein, and the data is displayed 304 to user 350, whereupon end user (e.g., employee) can confirm whether or not the first image was captured properly 305 (in other words, verifying the first image and then validating it) and optionally print that confirmation 306. Once confirmed, the scanned first image and its partitioned fields with their unique identification number (UID) are stored on the ASP's server for later authentication purposes 307.

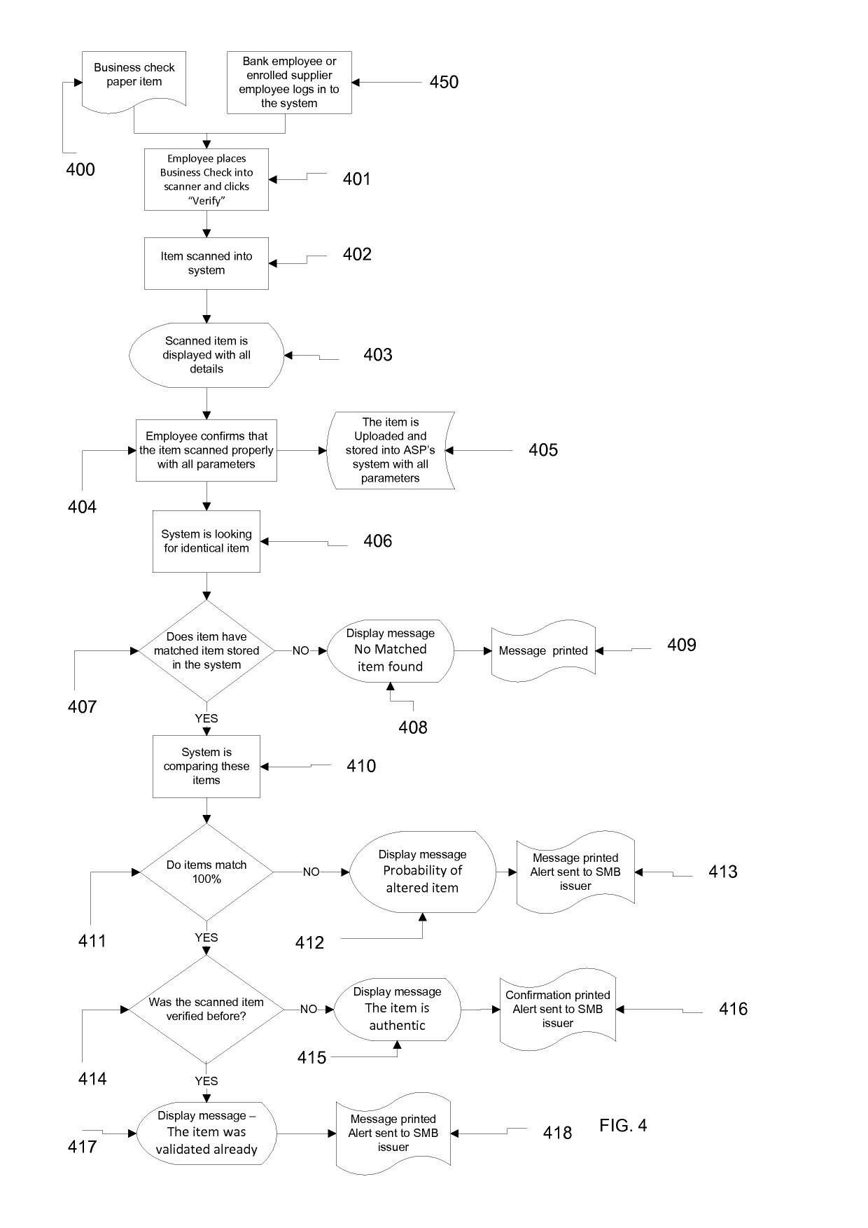

Similarly, authentication of a received business check is illustrated in FIG. 4. As illustrated, an end user 450 in the second data access module (user station) can log on to the ASP's system and capture the second image 402 of the paper financial instrument 400. At which point, the scanned second image of paper financial instrument 400 (e.g., the business check sought to be deposited or cashed) is uploaded (e.g., through WAN network) to the ASP's system 402, using the data processing module, in combination with the image processing module, the second image of paper financial instrument 400 is partitioned to a plurality of fields as described herein, and the data is displayed 403 to user 450. Similar to the issuing process in the first data access module, end user 450 (e.g., employee), can confirm whether or not the second image of paper financial instrument 400 was captured properly 404 (in other words, verifying the second image and then validating it). Once confirmed, the scanned second image and its partitioned fields with their unique identification number (UID) are uploaded to, and stored on the ASP's server for comparison and authentication purposes 405. Using at least one of the partitioned fields from the second image, the ASP's system, utilizing the data processing module, the ASP's system can search 406 for a verified and validated matching image of a paper financial instrument (e.g., 300, see e.g., FIG. 3).

Once the ASP's data processing module, completes the search, various sequential decision points are employed to authenticate the second paper financial instrument 400. For example, the system queries whether or not the image and partitioned fields matches any image or partitioned fields stored on the data processing modules' memory 407, else, the system can display a message that no matching paper item was found 408, which can then be printed 409; if a match exists and following a comparison by the data processing module 410, whether or not the plurality of fields identified and partitioned in the first image are identical to the plurality of fields identified and partitioned in the second image 411, else, the system can display a message that the item may have been altered 412, which can then be printed 413.

If identical match is found, whether or not the first image (see FIG, 3, 307) has already gone an authentication/verification process 414 by another end user 450 at another location (e.g., second data access point, or user station) and has therefore been paid to the holder. In other words, providing at least a reasonable evaluation and/or warning as to whether or not the financial instrument being verified for authentication can be a duplicate 418. If the item has been verified by a second data access module, the system can be configured to display a message to that effect 417, else, the system can display a message that the paper item is authentic 415, which can then be confirmed to the SMB issuer (see e.g., FIG. 3).

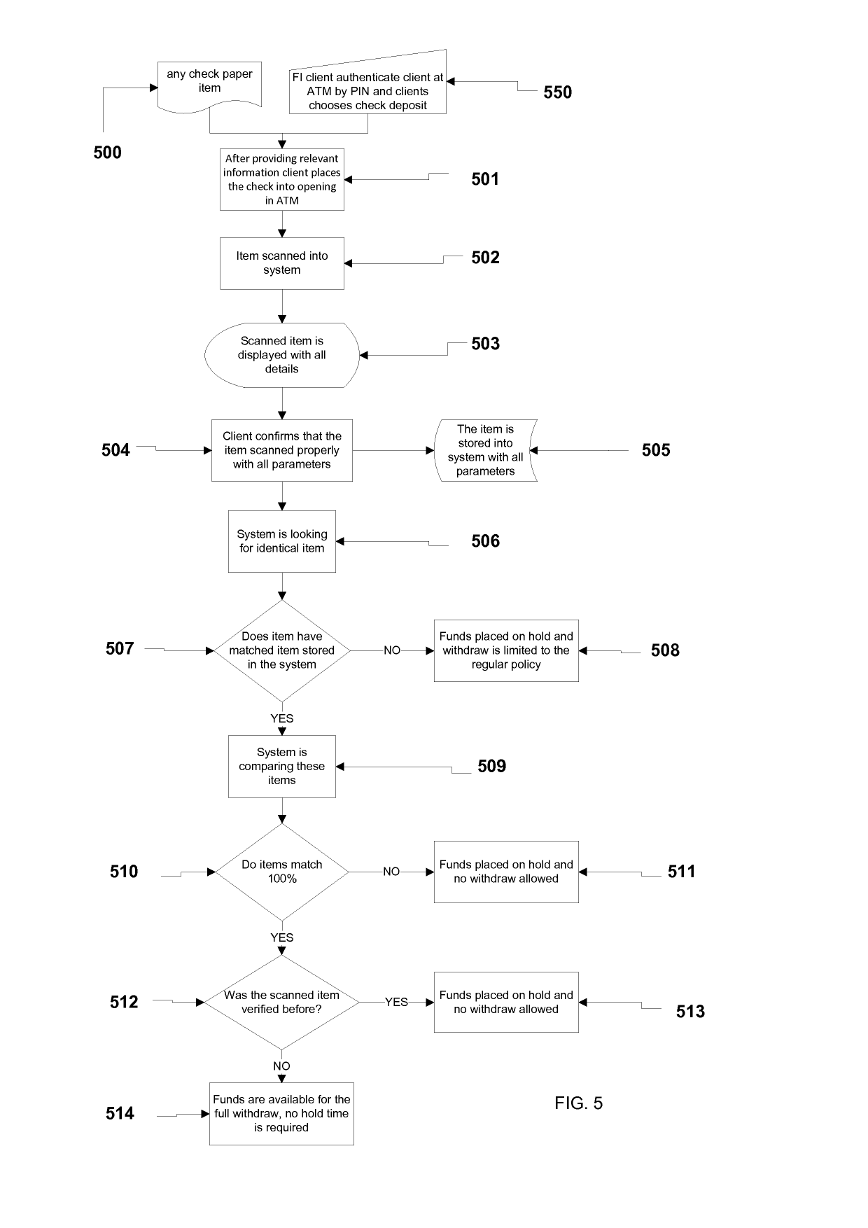

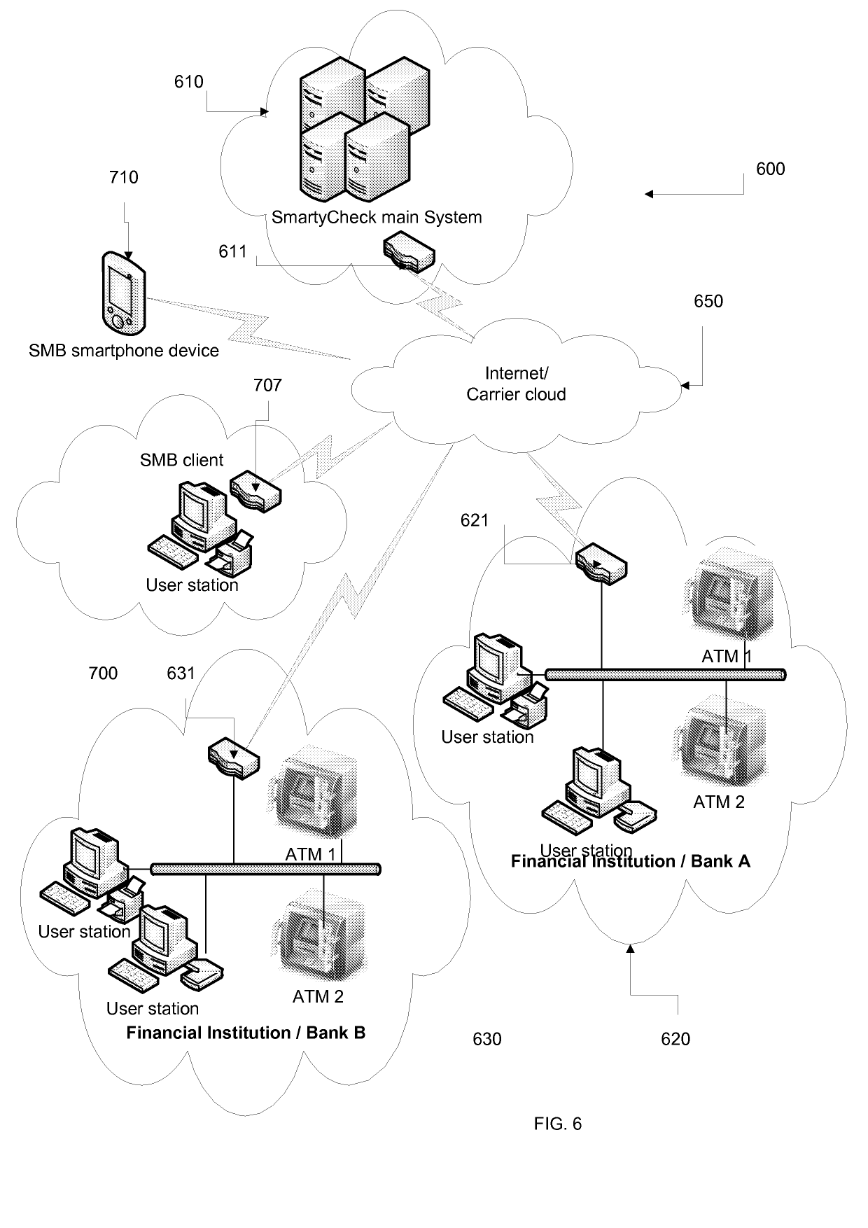

The systems and methods described herein, can operate in combination when the second data access module is an automated teller machine (ATM). As illustrated in FIG. 5, As illustrated, an end user (e.g., client) 550, e.g., a bearer of paper financial instrument 500 client can be authenticated as a client at an ATM by PIN. Client 550 can choose check deposit, in the ATM (see e.g., FIG. 6). After providing relevant information client scans the paper financial instrument (e.g., business check for a salary) using the ATM 501, and capture the second image 501 of the paper financial instrument 500. At which point, the scanned second image of paper financial instrument 500 is uploaded (e.g., through WAN network) to the ASP's system 502, using the data processing module, in combination with the image processing module, the second image of paper financial instrument 500 is partitioned to a plurality of fields as described herein, and the data is displayed 503 to client 550. Similar to the issuing process in the first data access module, client 550 (e.g., employee), can confirm whether or not the second image of paper financial instrument 500 was captured properly 504 (in other words, verifying the second image and then validating it). Once confirmed, the scanned second image and its partitioned fields with their unique identification number (UID) are uploaded to, and stored on the ASP's server for comparison and authentication purposes 505. Using at least one of the partitioned fields from the second image, the ASP's system, utilizing the data processing module, the ASP's system can search 506 for a verified and validated matching image of a paper financial instrument (e.g., 300, see e.g., FIG. 3).

Once the ASP's data processing module, completes the search, various sequential decision points can be employed to authenticate the second paper financial instrument 500. For example, the system queries whether or not the image and partitioned fields matches any image or partitioned fields stored on the data processing modules' memory 507. If not, the system can display a message that no matching paper item was found place the funds on hold, limiting withdrawal to the ATM's operator regular policy 508. If however, a match does exist and following a comparison by the data processing module 509, whether or not the plurality of fields identified and partitioned in the first image are identical to the plurality of fields identified and partitioned in the second image 510, else, the system can display a message that no identical match was found, place the funds on hold, and prohibiting withdrawal of any funds from the ATM 511.

If identical match is found however, the system queries whether or not the first image (see FIG. 3, 307) has already been authenticated/verified 512 by another client 550 at another location (e.g., second data access point, or ATM) and has therefore been paid to the holder. In other words, providing at least a reasonable evaluation and/or warning as to whether or not the financial instrument being verified for authentication can be a duplicate. If the item has been verified by a second data access module or ATM, the system can be configured to display a message to that effect, place the funds on hold, and prohibiting withdrawal of any funds from the ATM 513, else, the system can display a message that paper item 500 is authentic allowing immediate access to funds without any hold time 514.

As indicated, “SmartyCheck Verified”™ (SCV) backend management server can be configured to search the database (e.g., memory of the first data access and second data access modules) for matches. As per definitions above, the system also logs the financial institution and its branch that searches for an item. The verification log can register the UID of the scanning Customer Service Representative, date, time, bank, transit number, and address of the institution. As such, if an item is scanned at a second or third location, “duplicate” alert message can be shown to advise the depositing branch of a possible fraud attempt.

For example, in issuing a draft, certified check or money order; standard bank protocols and procedures can be followed, whereby a bank employee prepares a financial instrument and obtains all necessary authorizing signatures. Prior to providing the customer with the item(s), the following steps should be taken: the bank employee can log into a station (see e.g., FIG. 7), where “SmartyCheck Verified”™ software can be executed. The employee can then place item(s) into the scanner and selects “Scan” on the screen through “SmartyCheck Verified”™ software, passing the item through the scanner. The “SmartyCheck Verified”™ system (e.g., backend management and content server using, e.g., the image processing module in wired or wireless communication with the processor executing the set of instructions implemented by the “SmartyCheck Verified”™ software) captures the image and partitions the image to the relevant parameters of the item, and stores them on the secure (management/content) server. “SmartyCheck Verified”™ can then display the scanned item with, for example, an identified amount for confirmation. The bank employee can then approve the image, amount and item details, at which point, a confirmation message can be displayed (see e.g., monitor 704, FIG. 7), with a unique confirmation number, following which, the employee can issue the draft. In addition, the employee may print this confirmation message.

Returning to FIG. 2, When a bank representative 250 is presented with item(s) 200, she/he will scan the item 201 using “SmartyCheck Verified”™ system for authentication. As illustrated, Employee 250 logs into the station where “SmartyCheck Verified”™ software is executed. The employee can place item 200 into the scanner and clicks “Verify” button on the “SmartyCheck Verified”™ software 201, passing item 200 through the scanner. “SmartyCheck Verified”™ system (or backend content/management server) captures 202 the second image and all relevant parameters of the item 203 and looks for a matching item in the database 206. If no matching item has been found, or there is a probability that the item has been altered, the system will display and print the appropriate message 208. If the matched item has been found in the database 207 and there is no evidence that this item has been previously scanned, “SmartyCheck Verified”™ will display and print an approval message 215. If the matched item has been found in the database, but this item has already been scanned for verification by another branch or financial institution, “SmartyCheck Verified”™ can display 217 and print the appropriate message 218, as well as send various alerts to stake holder parties. The bank representative can print confirmation and follow standard protocol at the bank for a deposit (or other action if item is fraudulent or altered).

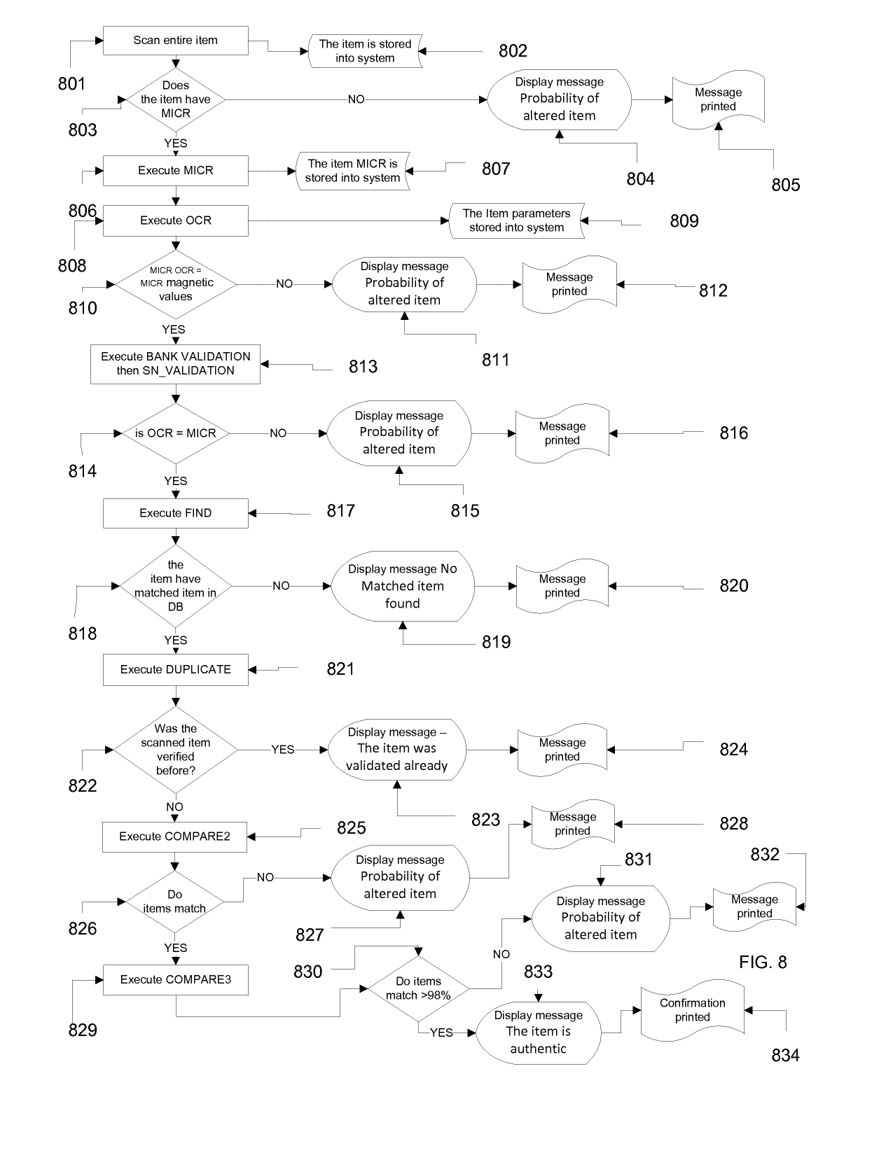

In an example for an algorithm for authenticating a paper financial instruments (see e.g., FIG. 8) by an issuing institution:
Scan entire item 801
MICR
Scan MICR code (section 2) with MICR reader
If MICR exists: 803
Read MICR magnetic values, Item Serial Number, Financial Institution (FI) code
(Section 1) and transit number (section 14)
Store them into database 807
Go to OCR 808
If no MICR exists: 803
Display message ‘Probability of altered item’ 811
OCR (sections 1-14 store in database)
Apply correct form template based on FI code from MICR reading and additional logic for OCR decoding
Read individual OCR values and store data in database.
Compare MICR magnetic values with MICR OCR values (section 2)
If MICR=OCR 810
Go to BANK VALIDATION 813
If MICR≠OCR
Display message ‘Probability of altered item’ 815
BANK VALIDATION 813
Get transit number from MICR reading (section 14)
Locate bank branch address based on transit number within pre-populated database
Compare address in pre populated database to OCR value in section 10
If values match,
Go to SN_VALIDATION 813
If they do not match,
Display message ‘Probability of altered item’ 815
SN_VALIDATION
Get SN number from MICR reading
Compare to OCR SN value in section 4
If values match,
Go to FIND 817
If do not match,
Display message ‘Probability of altered item’ 815
FIND 817
Search database for matching first image based on unique identification (UID)(MICR digits section 2) for comparison purposes;
Does item have match stored in the system?818
If YES
Go to DUPLICATE 821
If NO
Display message ‘No Matched item found’ 819
DUPLICATE 821
Check if this item has been validated already by another FI 822;
If YES, then
Flag additional attempt for validation (with time stamp and transit number)
Display message ‘The item was validated already’ 823
If NO, then
Flag attempt for validation.log the time stamp and transit number to database.
Go to step COMPARE2 825
COMPARE2 825
Compare OCR values (sections 810, 814) retrieved value to value. If match
Go to COMPARE3 829
If no match
Display message ‘Probability of altered item’ 827
COMPARE3 829
MICR data including digits, hand written values and signatures from originally issued item (e.g., first image) and validated item should be compared as image to image (similar to signature comparison).
If match 830
Display message ‘Item is authentic’ 833
Print confirmation 834
If no match 830
Display message ‘Probability of altered item’ 831

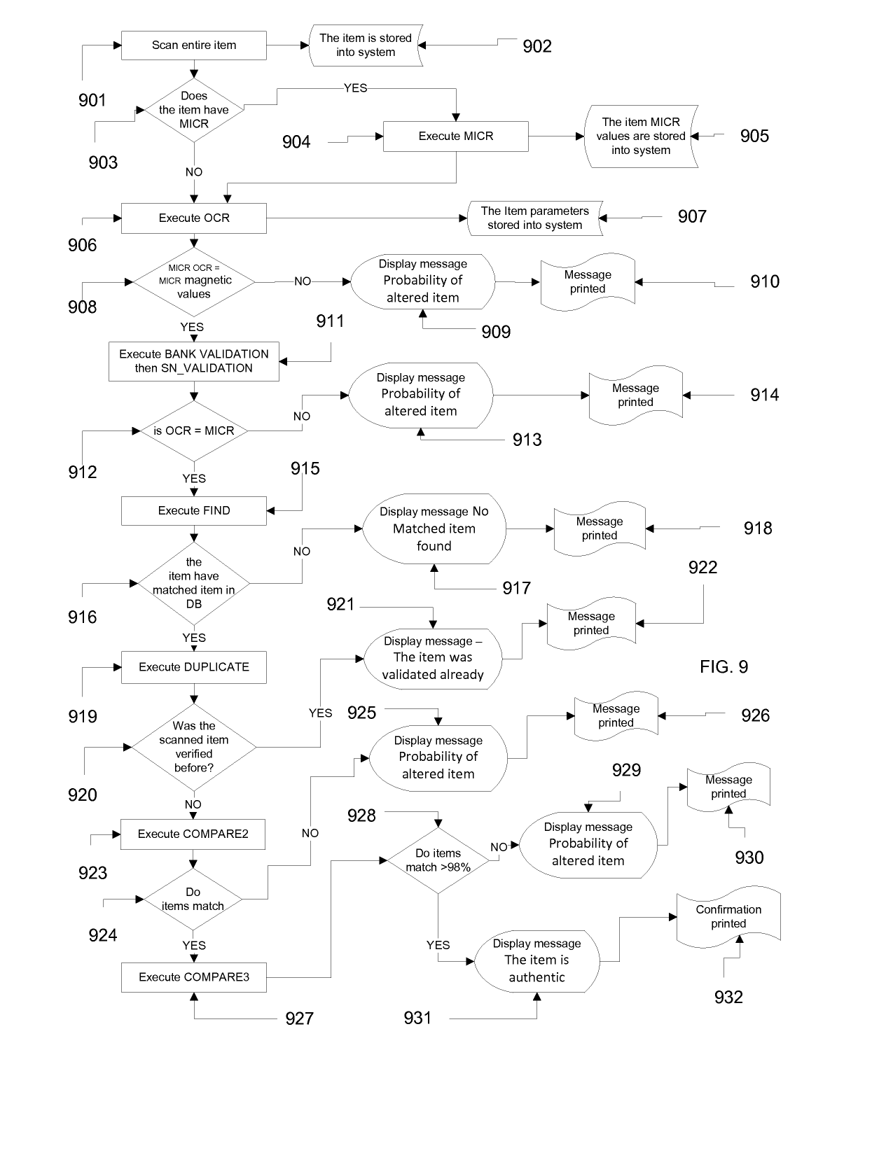

In an example for an algorithm for authenticating a paper financial instruments (see e.g., FIG. 9) by a small business:
Scan entire item 901
MICR
Scan MICR code (section 2) with MICR reader
If MICR exists: 903
Read MICR magnetic values, Item Serial Number, Financial Institution (FI) code and transit number
Store them into database 907
Go to OCR 904
If no MICR exists: 903
Go to OCR 906
If no section exist: 908
Display message ‘Probability of altered item’ 909
OCR
Apply correct form template based on FI code from MICR/OCR reading and additional logic for OCR decoding
Using OCR, read individual sections and store their values in database 907
Read individual OCR values and store data in database.
If MICR values exist 908
Compare MICR magnetic values with MICR OCR values 908
If MICR=OCR 912
Go to BANK VALIDATION
If MICR<>OCR
Display message ‘Probability of altered item’ 913
BANK VALIDATION 911
Get transit number from MICR reading
Locate bank branch address based on transit number within pre-populated database
Compare address in pre populated database to OCR value in section 10
If values match,
Go to SN_VALIDATION 911
If they do not match,
Display message ‘Probability of altered item’ 913
SN_VALIDATION 911
Get SN number from OCR
Compare to OCR SN value 912
If values match,
Go to FIND 915
If do not match,
Display message ‘Probability of altered item’ 913
FIND 915
Search database for matching image based on UID (digits section 2) for comparison purposes;
Does item have match stored in the system? 916
If YES
Go to DUPLICATE 919
If NO
Display message ‘No Matched item found’ 917
DUPLICATE 919
Check if this item has been validated already by another FI; 920
If YES, then
Flag additional attempt for validation (with time stamp and transit number)
Display message ‘The item was validated already’ 921
If NO, then
Flag attempt for validation.log the time stamp and transit number to database.
Go to step COMPARE2 823
COMPARE2 923
Compare OCR values (sections 3, 5) retrieved value to value 924. If match
Go to COMPARE3 927
If no match
Display message ‘Probability of altered item’ 925
COMPARE3 923
digits, hand written values and signatures from originally issued item and validated item should be compared as image to image (similar to signature comparison). 927
If match 928
Display message ‘Item is authentic’ 931
Print confirmation 932
If no match 928
Display message ‘Probability of altered item’ 929

FIG. 6 shows the architecture of system 600. System 600 can have various operational elements: a first “SmartyCheck Verified”™ Data Access Terminal (DAT) 620 or module, a second “SmartyCheck Verified”™ data access terminal or module 630; a SMB remote user station 700 (see e.g., FIG. 7) (implementing “SmartyCheck Business Protect”™ systems and methods), a backend Authentication Service Provider content and management server 610, Wide Area Network cloud provider 650 in communication with first “SmartyCheck Verified”™ Data Access Terminal (DAT) 620 via, for example, router 621; with second “SmartyCheck Verified”™ data access terminal or module 630 via, for example, 631; with remote user station 700 via for example router 707 or directly using SMB smartphone device 710; and with backend Authentication Service Provider content and management server 610 via, for example, router 611. As is known to persons of ordinary skill in the art, System 600 could also use other software development standard, other system deployment standards and other reliability standards as long as adherence to these alternative standards provides the security, availability and reliability required by mission critical financial applications.

In an embodiment, the image processing module used in the systems, programs and methods for authenticating paper financial instruments described herein can comprise: an optical character recognition (OCR) subsystem, an intelligent character recognition (ICR) subsystem, an image mapping comparison subsystem, a magnetic ink character recognition (MICR) subsystem, or a combination of imaging subsystems comprising two or more of the foregoing.

Neural-network ICR engines can be trained from scratch by exposing the subsystem to a character training set consisting of thousands of discreet images of characters that point to their ASCII values. The ICR engine can then be required to recognize a new set of characters (e.g., in the financial instrument scanned) that are not part of the training set. Character images that are incorrectly recognized by the engine are as simulated into the original training set and the engine is retrained on the new set. This process can be repeated until the accuracy of the engine meets certain predefined standards on arbitrary collections of real world image data, which standards are based upon comparable performance by professional data entry personnel (e.g., >98% accuracy). For example, there are a number of character recognition engines that could be employed by “SmartyCheck Verified”™ and “SmartyCheck Business Protect”™ system. The ICR engines that could currently be used by the “SmartyCheck Verified”™ and “SmartyCheck Business Protect”™ system can be, for example, FieldScript and CheckScript, v2.2. by Parascript (Colorado Springs, Colo.) for LAR; Quickstrokes v2.4, by Mitek (San Diego, Calif.); OrboCAR v2.13, by OrboGraph (Israel) for CAR (character amount recognition), and Wordscan Plus, 1998 edition, by Caere for OCR of machine print.

Likewise, image mapping comparison refers to both aggregate image maps as well as image maps corresponding to true full backup images (e.g., stored in the memory of the first data access module), or incremental backup images. For example, a given aggregate image map of the scanned paper financial instrument (PFI) may include pointers to any desired collection of entries within other image maps, including one or more other aggregate image maps (some of whose entries may point to entries within one or more other aggregate image maps as well as image maps corresponding directly to backup images (for example, already verified and authenticated PFI's). Thus, when following a pointer from a given entry of an aggregate image map to a corresponding data block, multiple intermediate entries at different layers within a hierarchy of image maps may be encountered. In certain embodiments, when a choice may exist between using multi-layer aggregate image maps or using the underlying full and incremental image maps when establishing a requested aggregate image, a backup image processing processor manager may be configured to allow a user to indicate a preference between the possible choices. For example, a user may specify a maximum or desired number of layers or a desired image map hierarchy structure for a requested aggregate image map.

Further and as part of the recognition process, a MICR magnetic read head can be used to read the information printed on the PFI. Typically, approaches to MICR generally involve the step of determining peak information for a waveform generated by the magnetic read head. This peak information can typically include information regarding the amount of time between the peaks of each character. Knowledge of the velocity of the document (and thus, the character contained therein) allows this time information to be converted into distance information, which can be compared to each MICR character and their peak profiles as contained for example, in the ANS X9.27-2000 “ Print and Test Specifications for Magnetic Ink Printing (MICR)” as promulgated by the American National Standards Institute.

As indicated, the PFI can be is a Money Order, a Draft, a Certified Check, a Cashier's Check, a Bearer Bond, a Bearer share, or a paper financial instrument comprising one or more of the foregoing.

In an embodiment, the systems described herein, are used in the methods provided herein. Accordingly, provided herein is a method of authenticating a paper financial instrument, comprising: receiving a first image corresponding to a first paper financial instrument from a first data module; receiving a second image corresponding to a second paper financial instrument from a second data access module; partitioning the first image into a plurality of fields; partitioning the second image into the same plurality of fields; comparing the plurality of fields of the second image to the plurality of fields of the first check image in order to determine a level of similarity between the second image and the first image; determining the degree of similarity between the second image and the first image; and if the degree of similarity is above a predetermined threshold, providing an authentication indicia to the second data access module.

As will be appreciated by one of ordinary skill in the art in view of this disclosure, the disclosed technology may include and/or be embodied as an apparatus (including, for example, a system, machine, device, computer program product, and/or the like), as a method (including, for example, a business method, computer-implemented process, and/or the like), or as any combination of the foregoing. Accordingly, certain embodiments disclosed herein may take the form of an entirely business method embodiment, an entirely software embodiment (including firmware, resident software, micro-code, etc.), an entirely hardware embodiment, or an embodiment combining business method, software, and hardware aspects that may generally be referred to herein as a “system.” Furthermore, embodiments disclosed herein may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function

Accordingly and in yet another embodiment, provided herein is a non-transitory computer-readable medium comprising computer-readable instructions for authenticating a paper financial instrument, said computer-readable instructions configured for causing a processor to: receive a first image corresponding to a first financial instrument from a first data module; receive a second image corresponding to a second financial instrument from a second data access module; partition the first image into a plurality of fields; partition the second image into the same plurality of fields; compare the plurality of fields of the second image to the plurality of fields of the first check image in order to determine a level of similarity between the second image and the first image; determine the degree of similarity between the first image and the second image; and if the degree of similarity is above a predetermined threshold value, provide an authentication indicia to the second data access module.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, .NET, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages.

Some embodiments disclosed herein are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

Further, the one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment disclosed herein.

The terms “customer”, “consumer”, “client” and formatives thereof as utilized herein refer to any party desiring to initiate interaction with an information/support service accessible by the methods and systems described herein and likewise is meant to include any individual, party, entity, or combination thereof that queries base level data and derived information from the systems and methods described, and may be used interchangeably with “user,” or “end-user”.

The system described herein, used to implement the methods described using the set of instructions implemented by the processor can also comprise: a plurality of heterogeneous hardware and software components (e.g., wired/wireless communications hardware/software) configured to implement the methods described herein thus providing one or more services. An additional Web Exchange module can comprise, for example, a service provider configured to provide access to the one or more services provided by the Web Exchange module via a network to one or more service requesters configured to access the one or more services via the service provider over the network. (See e.g., FIGS. 6, 7)

The Web Exchange system can be configured and implemented according to a vendor-independent Web Cloud Service 650 architecture generated according to a structured design process for designing and generating vendor-independent Web Could Service architectures such that, for example, the plurality of heterogeneous hardware components are organized according to two or more tiers and two or more layers of the Web Exchange architecture, and/or one or more Web Exchanges design patterns are applied to the Web Exchange architecture, such that each design pattern models a particular structure that is applicable to the Web Exchange. For example, one Web Exchange design pattern/architecture may be associated with providing SmartyCheck Verified”™ associated services, while a second Web Exchange design pattern/architecture may be associated with providing “SmartyCheck Business Protect”™ associated services.

An end-user interface component, with the end-user and/or user-specific data having an internal content representation that correlates to an external appearance in a plurality of content option can be provided. The end-user (e.g., SMB) interface and/or user-specific data server can incorporate the requested data retrieved from the ASP's main server, into a current view in the end-users' display means. The SMB's data server can for example, be coupled to the end-user dedicated interface. The end-user interface can be configured to retrieve requested data incorporated into the ASP's database's server and to display the requested data retrieved as one or more content items.

The terms “content and/or management server” or “user specific data server”, when used, refer to a back-end hardware and software product that is used to manage content. likewise, the term “in communication with” refers in an embodiment, to any coupling, connection, or interaction using electrical signals to exchange information or data, using any system, hardware, software, protocol, or format.

The terms “first,” “second,” and the like, herein do not denote any order, quantity, or importance, but rather are used to denote one element from another. The terms “a”, “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the item(s) includes one or more item). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

Communication among the system components can be achieved over a plurality of communication paths. The term “communication path” refers to a communication format that has multiple channels. For example, contemplated communication paths include radio frequency bands, including NOAA frequency band, EAS frequency band, various UHF and/or VHF frequency bands, microwave and infrared frequency bands, frequency bands used for cellular communication, cable and/or satellite TV transmission systems, optical network systems, and/or high-speed digital data transmission systems. The term “channel” can refer to a specific modality within the communication path. For example, where the communication path is cellular communication (e.g., 824-849 MHz, 869-894 MHz, or 1850-1990 MHz), the channel may be a single frequency, or a spectrum of multiple frequencies (e.g., CDMA signal) within that communication path Likewise, where the communication path is a fiber optic cable system, channels will correspond to high-speed (e.g., >1.0 Mb/s) digital data transmission system, a channel may be a network address.

Also, the term “non-transitory computer-readable medium” may include a single medium or multiple media (e.g., a centralized or distributed database, or associated caches and servers) that store the one or more instructions. The term “non-transitory computer-readable medium” shall also be taken to include any tangible medium that is capable of storing, encoding, or carrying instructions for execution by the machine and that cause the machine to perform any one or more of the methodologies disclosed herein, or that is capable of storing, encoding, or carrying data structures used by or associated with such instructions. The term “non-transitory computer-readable medium” shall accordingly be taken to include, but not be limited to, solid-state memories, and optical and magnetic media. Specific examples of non-transitory machine-readable media include non-volatile memory, including by way of exemplary semiconductor memory devices (e.g., EPROM, EEPROM, and flash memory devices); magnetic disks such as internal hard disks and removable disks; magneto-optical disks; and CD-ROM and DVD-ROM disks. The term “disk” as used herein refers to a storage disk or other memory that can store data for a computer system.

The software, information and/or data may further be transmitted or received over a global communications network using a transmission medium via a network interface device utilizing (see e.g., router 621, FIG. 6) any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., LTE, WiFi and WiMax networks). The term “transmission medium” shall be taken to include any intangible medium that is capable of storing, encoding, or carrying instructions for execution by the machine (e.g., a computer), and includes digital or analog communications signals or other intangible medium to facilitate communication of such software. In an embodiment, the methods described herein make use of the systems and non-transitory, computer-readable medium provided herein.

For example, a machine in the exemplary form of a computer system within which the instructions, for causing the machine to perform any one or more of the methods provided herein, may be executed. The machine can for example operate as a standalone device (e.g., SMB PDA 710, FIG. 6) or may be connected (e.g., networked) to other machines (e.g., ATMs). In a networked deployment, the machine may operate in the capacity of a server or a client machine in server-client network environment, or as a peer machine in a peer-to-peer (or distributed) network environment (e.g., when the first and second data access modules are in the same institution but in different locations). The machine may be a personal computer (PC), a tablet PC, a set-top box (STB), a Personal Digital Assistant (PDA), a cellular telephone, a web appliance, a network router, a switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methods disclosed herein.

In addition, the program may be further configured to execute commands directed to initiating communication between a user (e.g., the second data access module) and the ASP's database over a communication network configured to upload information from the second data access module user and the non-transitory, computer readable medium; and initiating communication between the user server(s). In initiating communication, the command can execute direct transmission and reception of signals without connecting through any base stations or servers by, for example, wireless signal transmission means such as electric waves or through cables.

Moreover, plural instances may be provided for resources, operations, or structures described herein as a single instance. Additionally, boundaries between various resources, operations, modules, engines, and data stores are somewhat arbitrary, and particular operations are illustrated (see e.g., FIG. 6) in a context of a specific illustrative configurations. Other allocations of functionality are envisioned and may fall within a scope of various embodiments disclosed herein. In general, structures and functionality presented as separate resources in the exemplary configurations may be implemented as a combined structure or resource. Similarly, structures and functionality presented as a single resource may be implemented as separate resources.

Accordingly and in an embodiment, provided herein is a system for authentication and verification of a paper financial instrument comprising: a first data access module comprising at least one imaging subsystem; an image processing module; a second data access module comprising at least one imaging subsystem a data processing module comprising: a memory; and a processor in communication with the memory, the first data access module, the second data access module, and the image processing module, wherein the processor is configured to: receive a first image corresponding to a first financial instrument from the first data module; receive a second image corresponding to the second data access module; partition the first image into a plurality of fields; partition the second image into the same plurality of fields; compare the plurality of fields of the second image to the plurality of fields of the first check image in order to determine a level of similarity between the second image and the first image; determine the degree of similarity between the first image and the second image; and if the degree of similarity is above a predetermined threshold value, provide an authentication indicia to the second data access module, wherein (i) wherein the system further comprises a communication network in communication with the first data access module, the image processing module, the second data access module, and the data processing module, wherein (ii) the image processing module comprises: an optical character recognition (OCR) subsystem, an intelligent character recognition (ICR) subsystem, an image mapping comparison subsystem, a magnetic ink character recognition (MICR) subsystem, or a combination of imaging subsystems comprising two or more of the foregoing, wherein (iii) the paper financial instrument is a Money Order, a Draft, a Certified Check, a Cashier's Check, a Bearer Bond, a Bearer share,[What else?] or a financial instrument comprising one or more of the foregoing, wherein (iv) the communication network is a wide area network, a cellular network, a local area network, a wireless network, or a combination comprising one or more of the foregoing, wherein (v) the first data access module and/or the second data access module, is an issuer bank, an issuing small to medium business, an automatic teller machine, or a large business enterprise, and (vi) wherein the plurality of fields partitioned by the processor in the first and second images is a magnetic ink character recognition (MICR) line, Overall image as a whole, Date, Serial number, All signatures, Payee Name, Amount CAR/LAR, Issuing bank and branch details, Protectograph (shreds and indentations) and magnetic ink values, Hand written or printed item value.

In another embodiment, provided herein is a method of authenticating a paper financial instrument, comprising: receiving a first image corresponding to a first paper financial instrument from a first data module; receiving a second image corresponding to a second paper financial instrument from a second data access module; partitioning the first image into a plurality of fields; partitioning the second image into the same plurality of fields; comparing the plurality of fields of the second image to the plurality of fields of the first check image in order to determine a level of similarity between the second image and the first image; determining the degree of similarity between the second image and the first image; and if the degree of similiarity is above a predetermined threshold value, providing an authentication indicia to the second data access module, wherein (vii) partitioning the first and the second images of the paper financial instrument comprises using an image processing module, the module comprising an optical character recognition (OCR) subsystem, an intelligent character recognition (ICR) subsystem, an image mapping comparison subsystem, a magnetic ink character recognition (MICR) subsystem, or a combination of imaging subsystems comprising two or more of the foregoing, wherein (viii) the paper financial instrument is a Money Order, a Draft, a Certified Check, a Cashier's Check, a Bearer Bond, a Bearer share, or a paper financial instrument comprising one or more of the foregoing, wherein (ix) the predetermined threshold of the degree of similarity between the second image and the first image in the step of providing the authentication indicia is equal to or greater than 98% similarity, or is based upon comparable comparison performance by professional data entry personnel, wherein (x) the plurality of fields partitioned in the first and second images in the steps of partitioning, is a magnetic ink character recognition (MICR) line, Overall image as a whole, Date, Serial number, All signatures, Payee Name, courtesy amount recognition (CAR), legal amount recognition (LAR), Issuing bank and branch details, Protectograph and magnetic ink values, Hand written value, or printed item value, wherein (xi) the first data access module and/or the second data access module, is an issuer bank, an issuing small to medium business, an automatic teller machine, or a large business enterprise, and wherein (xii) the steps of receiving a first image corresponding to a first paper financial instrument from a first data module, receiving a second image corresponding to a second paper financial instrument from a second data access module, and providing an authentication indicia to the second data access module comprise using a wide area network, a cellular network, a local area network, a wireless network, or a combination comprising one or more of the foregoing.

In yet another embodiment, provided herein is a non-transitory computer-readable medium comprising computer-readable instructions for authenticating a paper financial instrument, said computer-readable instructions configured for causing a processor to: receive a first image corresponding to a first financial instrument from a first data module; receive a second image corresponding to a second financial instrument from a second data access module; partition the first image into a plurality of fields; partition the second image into the same plurality of fields; compare the plurality of fields of the second image to the plurality of fields of the first check image in order to determine a level of similarity between the second image and the first image; determine the degree of similarity between the first image and the second image; and if the degree of similarity is above a predetermined threshold value, provide an authentication indicia to the second data access module, (xiii) to partition the first and the second images of the paper financial instrument comprises using an image processing module, the module comprising an optical character recognition (OCR) subsystem, an intelligent character recognition (ICR) subsystem, an image mapping comparison subsystem, a magnetic ink character recognition (MICR) subsystem, or a combination of imaging subsystems comprising two or more of the foregoing, (xiv) wherein the plurality of fields partitioned in the first and second images, is a magnetic ink character recognition (MICR) line, Overall image as a whole, Date, Serial number, All signatures, Payee Name, courtesy amount recognition (CAR), legal amount recognition (LAR), Issuing bank and branch details, Protectograph and magnetic ink values, Hand written value, or printed item value, (xv) to receive the first image corresponding to the first paper financial instrument from the first data access module, receive the second image corresponding to the second paper financial instrument from the second data access module, and provide the authentication indicia to the second data access module by using a wide area network, a cellular network, a local area network, a wireless network, or a combination comprising one or more of the foregoing, (xvi) wherein the first data access module and/or the second data access module, is an issuer bank, an issuing small to medium business, an automatic teller machine, or a large business enterprise, and (xvii) to provide the authentication indicia if the determined similarity between the second image and the second image is equal to or greater than 98% similarity, or is based upon comparable comparison performance by professional data entry personnel.

While in the foregoing specification the methods and systems have been described in relation to certain embodiments, and many details are set forth for purpose of illustration, it will be apparent to those skilled in the art that the disclosure is susceptible to additional embodiments and that certain of the details described in this specification and as are more fully delineated in the following claims can be varied considerably without departing from the basic principles of this invention.

1. A system for authentication and verification of a paper financial instrument comprising:
a. a first data access module comprising at least one imaging subsystem;
b. an image processing module;
c. a second data access module comprising at least one imaging subsystem
d. a data processing module comprising: a memory; and a processor in communication with the memory, the first data access module, the second data access module, and the image processing module, wherein the processor is configured to: receive a first image corresponding to a first financial instrument from the first data module; receive a second image corresponding to the second data access module; partition the first image into a plurality of fields; partition the second image into the same plurality of fields; compare the plurality of fields of the second image to the plurality of fields of the first image in order to determine a level of similarity between the second image and the first image; determine the degree of similarity between the first image and the second image; and if the degree of similarity is above a predetermined threshold value, provide an authentication indicia to the second data access module.

2. The system of claim 1, wherein the system further comprises a communication network in communication with the first data access module, the image processing module, the second data access module, and the data processing module.

3. The system of claim 2, wherein the image processing module comprises: an optical character recognition (OCR) subsystem, an intelligent character recognition (ICR) subsystem, an image mapping comparison subsystem, a magnetic ink character recognition (MICR) subsystem, or a combination of imaging subsystems comprising two or more of the foregoing.

4. The system of claim 3, wherein the paper financial instrument is a Money Order, a Draft, a Certified Check, a Cashier's Check, a Bearer Bond, a Bearer share, or a paper financial instrument comprising one or more of the foregoing.

5. The system of claim 2, wherein the communication network is a wide area network, a cellular network, a local area network, a wireless network, or a combination comprising one or more of the foregoing.

6. The system of claim 3, wherein the first data access module and/or the second data access module, is an issuer bank, an issuing small to medium business, an automatic teller machine, or a large business enterprise.

7. The system of claim 6, wherein the plurality of fields partitioned by the processor in the first and second images is a magnetic ink character recognition (MICR) line, Overall image as a whole, Date, Serial number, All signatures, Payee Name, Amount CAR/LAR, Issuing bank and branch details, Protectograph and magnetic ink values, Hand written or printed item value.

8. A method of authenticating a paper financial instrument, comprising:
a. receiving a first image corresponding to a first paper financial instrument from a first data module;
b. receiving a second image corresponding to a second paper financial instrument from a second data access module;
c. partitioning the first image into a plurality of fields;
d. partitioning the second image into the same plurality of fields;
e. comparing the plurality of fields of the second image to the plurality of fields of the first check image in order to determine a level of similarity between the second image and the first image;
f. determining the degree of similarity between the second image and the first image; and
g. if the degree of similarity is above a predetermined threshold, providing an authentication indicia to the second data access module.

9. The method of claim 8, wherein partitioning the first and the second images of the paper financial instrument comprises using an image processing module, the module comprising an optical character recognition (OCR) subsystem, an intelligent character recognition (ICR) subsystem, an image mapping comparison subsystem, a magnetic ink character recognition (MICR) subsystem, or a combination of imaging subsystems comprising two or more of the foregoing.

10. The method of claim 9, wherein the paper financial instrument is a Money Order, a Draft, a Certified Check, a Cashier's Check, a Bearer Bond, a Bearer share, or a paper financial instrument comprising one or more of the foregoing.

11. The method of claim 10, wherein the predetermined threshold of the degree of similarity between the second image and the first image in the step of providing the authentication indicia is equal to or greater than 98% similarity, or is based upon comparable comparison performance by professional data entry personnel.

12. The method of claim 11, wherein the plurality of fields partitioned in the first and second images in the steps of partitioning, is a magnetic ink character recognition (MICR) line, Overall image as a whole, Date, Serial number, All signatures, Payee Name, courtesy amount recognition (CAR), legal amount recognition (LAR), Issuing bank and branch details, Protectograph and magnetic ink values, Hand written value, or printed item value.

13. The method of claim 12, wherein the first data access module and/or the second data access module, is an issuer bank, an issuing small to medium business, an automatic teller machine, or a large business enterprise.

14. The method of claim 13, wherein the steps of receiving a first image corresponding to a first paper financial instrument from a first data module, receiving a second image corresponding to a second paper financial instrument from a second data access module, and providing an authentication indicia to the second data access module comprise using a wide area network, a cellular network, a local area network, a wireless network, or a combination comprising one or more of the foregoing.

15. A non-transitory computer-readable medium comprising computer-readable instructions for authenticating a paper financial instrument, said computer-readable instructions configured for causing a processor to: receive a first image corresponding to a first financial instrument from a first data module; receive a second image corresponding to a second financial instrument from a second data access module; partition the first image into a plurality of fields; partition the second image into the same plurality of fields; compare the plurality of fields of the second image to the plurality of fields of the first check image in order to determine a level of similarity between the second image and the first image; determine the degree of similarity between the first image and the second image; and if the degree of similarity is above a predetermined threshold value, provide an authentication indicia to the second data access module.

16. The non-transitory computer-readable medium of claim 15, wherein the computer-readable instructions are further executed by the processor to partition the first and the second images of the paper financial instrument comprises using an image processing module, the module comprising an optical character recognition (OCR) subsystem, an intelligent character recognition (ICR) subsystem, an image mapping comparison subsystem, a magnetic ink character recognition (MICR) subsystem, or a combination of imaging subsystems comprising two or more of the foregoing.

17. The non-transitory computer-readable medium of claim 16, wherein the plurality of fields partitioned in the first and second images, is a magnetic ink character recognition (MICR) line, Overall image as a whole, Date, Serial number, All signatures, Payee Name, courtesy amount recognition (CAR), legal amount recognition (LAR), Issuing bank and branch details, Protectograph and magnetic ink values, Hand written value, or printed item value.

18. The non-transitory computer-readable medium of claim 17, wherein the computer-readable instructions are further executed by the processor to receive the first image corresponding to the first paper financial instrument from the first data access module, receive the second image corresponding to the second paper financial instrument from the second data access module, and provide the authentication indicia to the second data access module by using a wide area network, a cellular network, a local area network, a wireless network, or a combination comprising one or more of the foregoing.

19. The non-transitory computer-readable medium of claim 17, wherein the first data access module and/or the second data access module, is an issuer bank, an issuing small to medium business, an automatic teller machine, or a large business enterprise.

20. The non-transitory computer-readable medium of claim 19, wherein the computer-readable instructions are further executed by the processor to provide the authentication indicia if the determined similarity between the second image and the second image is equal to or greater than 98% similarity, or is based upon comparable comparison performance by professional data entry personnel.
